(19) United States
(12) Patent Application Publication
(10) Pub. No.: US 2026/0312529 A1
(43) Pub. Date: Oct. 8, 2026

(54) Ganged Photovoltaic (PV) Installation and Assembly Jig

(71) Applicants: National Technology & Engineering Solutions of Sandia, LLC, Albuquerque, NM (US); Skysun LLC, Bay Village, OH (US)

(72) Inventors: Kenneth M. Armijo, Albuquerque, NM (US); James Joseph Clair, Bay Village, OH (US)

(21) Appl. No.: 19/213,539

(22) Filed: May 20, 2025

Related U.S. Application Data
(60) Provisional application No. 63/650,692, filed on May 22, 2024.

(51) Int. Cl. H02S 20/32; H02S 40/36

(52) U.S. Cl. CPC H02S 20/32; H02S 40/36

(57) ABSTRACT

The present disclosure is generally directed to installing photovoltaic (PV) ganged systems in a simplistic and cost effective way that delivers repetitive and consistent installation.

### CROSS-REFERENCE TO RELATED APPLICATIONS

This application claims priority to U.S. Provisional Patent Application No. 63/650,692, entitled “Ganged PV Assembly and Deployment Jig,” filed May 22, 2024, which is incorporated herein by reference in its entirety.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD

The present disclosure is generally directed to installing photovoltaic (PV) systems, and more specifically directed to a simplistic and cost effective installation system that delivers repetitive and consistent installation by means of field deployment of pre-assembled strings of ganged PV of a tensile nature.

### BACKGROUND

Arrays of PV panels that are installed in fields require large labor costs to install. In addition, the arrays are difficult to install in a consistent and cost effective manner. Typically, modules are shipped palletized with approximately 25 modules per pallet depending on manufacturer. Individual pallets are deployed at/near an install location with one or two laborers carrying a module to one or two installers at typically rigid-racking. Installer(s) fasten the module to the racking and are followed by an electrical technician(s) connecting multiple module leads, in series or parallel, into a group of modules known as a string, where a string is normally comprised of 10 to 30 modules with string size dependent upon inverter and junction box size and type. In short, in the current art modules are usually installed one at a time.

Hinged and rigid ganged PV deployment methods utilizing an accordion style method of ganging are being attempted, however such methodology requires substantial mechanical infrastructure for the hinged movement and specialized transport, further, deployment is typically limited to alternating tilt angles with the resulting net tilt of 0° significantly decreasing power production and efficiency.

Current method requires the majority of both mechanical and electrical connections to be made in the field subject to the vagaries of weather and terrain amongst others.

What is needed are PV installation and assembly systems and methods that overcome the deficiencies of the prior art.

### BRIEF SUMMARY OF THE INVENTION

The present systems and methods provide for simple “plug and play” installation in the field of tensile based PV systems. In an embodiment, the PV system may include one or more PV modules. In another embodiment, the PV system may include two or more ganged PV modules. The systems and methods allow for assembly and deployment at the installation site, rather than module level fabrication site, while maintaining plug and play simplicity.

This disclosure is directed to a jig that includes a table; a support configured to attach at least one photovoltaic (PV) module to the table; and a support system configured to elevate the table above a horizontal surface. The support system comprises vertical supports attached to a cross-member and a rotational device attached to both the table and cross-member that allows the table to rotate about the cross-member without impacting the horizontal surface.

The present disclosure is also directed to a method of assembling a string of one or more photovoltaic (PV) modules for installation that includes attaching the one or more PV module to a table so a surface of the PV module faces away from the table; rotating the table so the surface of the PV module faces downward; providing a support platform parallel to the surface; bringing the surface in contact with the support platform; and disengaging the one or more PV module from the table.

The present disclosure is further directed to a photovoltaic (PV) installation method that includes loading one or more PV modules by a process that includes attaching the one or more PV module to a table so a surface of the PV module faces away from the table; rotating the table so the surface of the PV module faces downward; providing a support platform parallel to the surface; bringing the surface in contact with the support platform; and disengaging the one or more PV module from the table onto a support platform. The method further includes delivering the support platform supporting the one or more PV modules to a PV installation location; positioning the support platform and one or more PV modules between PV supports; attaching the one or more PV modules to the PV supports; and separating the support platform from the one or more PV modules so the one or more PV modules are suspended between the PV supports.

An advantage of the present disclosure is providing for the installation in the field or at a utility site of PV arrays that are pre-assembled at a central location that reduces labor and/or inclement weather down time. In an embodiment, the PV array may include a string of several PV panels.

Another advantage of the systems and methods is that they allow the PV strings to be mounted on posts with various heights of ground clearance allowing simplified dual land use such as Agrivoltaics, additionally, strings may be mounted and actuated to be elevatable to various heights above ground as needed.

A further advantage of the systems and methods is that they allow the strings to be mounted such that single access tracking (SAT) and dual access tracking (DAT) are possible thereby increasing power production.

Another advantage of this system would allow for the string to rotate to a face down position which, when combined with a lightweight skin such as coil stock aluminum sheet on the rear of the module, reduces or eliminates the possibility of hail damage. Also, many of the pre-assembled strings maybe stacked one on top of another and transported for field deployment on a conventional tractor trailer and mass deployed with a conventional telehandler.

Alternative, exemplary embodiments relate to other features and combinations of features as can be generally recited in the claims.

### BRIEF DESCRIPTION OF THE DRAWINGS

The application will become more fully understood from the following detailed description, taken in conjunction with the accompanying figures, wherein like reference numerals refer to like elements, in which:

FIG. 1A illustrates an installation and assembly jig according to an embodiment of the disclosure.

FIG. 1B is a rear view of the jig of FIG. 1.

FIG. 1C is a side view of the jig of FIG. 1.

FIG. 2 is an illustration of stacking PV Modules onto a pallet according to an embodiment of the disclosure.

FIG. 3 is an illustration of a PV module assembled onto ganged PV module system according to an embodiment of the disclosure.

### DETAILED DESCRIPTION OF THE EXEMPLARY EMBODIMENTS

The present disclosure is directed to systems and methods for the rapid assembly, deployment and installation in the field of pre-assembled, pre-wired, grounded tensile-based ganged photovoltaic (PV) arrays. The systems include an assembly jig that is designed to facilitate assembly at the string size level.

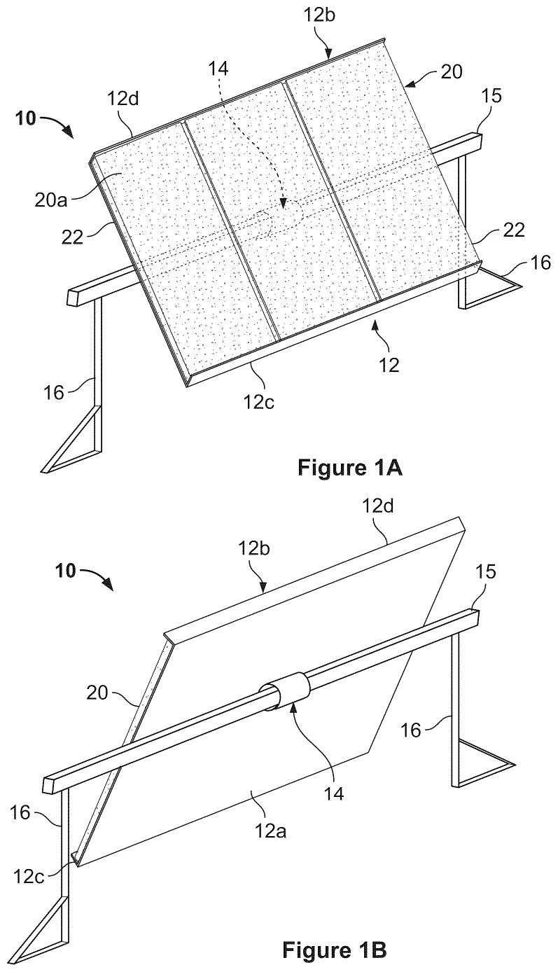

FIGS. 1A, 1B and 1C illustrate an installation and assembly jig (jig) 10 according to an embodiment of the disclosure. As can be seen in FIGS. 1, 1A and 1B, the jig 10 includes a support table 12, a rotatable connector 14, a cross-member or support beam 15 and support legs 16. The support table 12 is shown supporting a ganged, PV module string (PV string) 20 formed of three PV panels or modules 22. In this exemplary embodiment, the PV modules 22 are in a portrait orientation, meaning that the width of the panels along the axis of the beam 15 is less than the height as shown. The PV modules 22 may be single or bifacial. In other embodiments, the modules 22 may be in a landscape orientation. As used herein, the term “ganged” means that the modules are connected both electrically and mechanically. The support legs 16 are attached to the ground by any suitable attachment configurations including but not limited to attachment to ground anchors, ground penetration based foundations and/or by ballast.

In FIG. 1A, the table 12 and module string 20 are transparent for simplicity. The support table 12 includes a support base 12a and clamping devices or support arms 12b. The support arms 12b include a first support arm 12c and a second support arm 12d that temporarily affix the PV string 20 to the support table 12. The release of the PV string 20 from the table 12 will be discussed in greater detail in the following description. The support legs 16 elevate the PV string 20 above the ground at a sufficient height H (see FIG. 1C) to allow the table 12 and PV string 20 to rotate about the beam 15 without impacting the ground.

In this exemplary embodiment, the rotatable connector 14 is a sleeve that releasably attaches to the table 12 and beam 15 that allows the table 12 to rotate around the beam 15. In other embodiments, the connector 14 is any sleeve, cylinder, movable hinge or other device that engages the beam 15 and is releasably attached to the table 12 to allow the table to rotate. In other embodiments, the connector 14 may be releasably attached to the table 12 and beam 15, however, the beam 15 is rotatably attached to the support legs 16 so as to allow the beam 15 to rotate around the beams central axis.

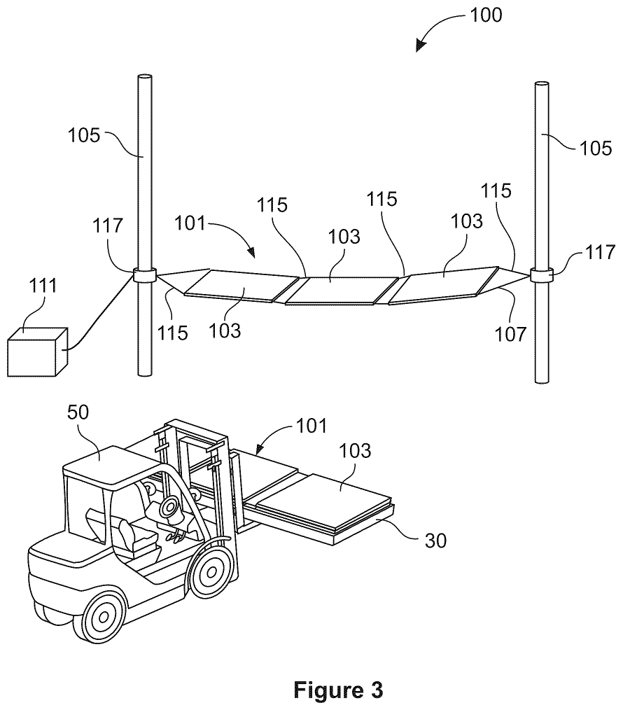

In this exemplary embodiment, the PV string 20 includes three PV modules 20a. In other embodiments, the PV string 20 may include one or more PV modules 20a. In other embodiments, the PV string 20 may include 5-30 PV modules. When two or more PV modules are used, the PV modules may be electrically connected in series or parallel or a combination of both. The PV string 20 includes electrical connections (not shown but as understood by one of ordinary skill) on opposing lateral ends 22 of the PV string 20. The electrical connections may be used to connect the PV module to additional PV modules, inverters, electrical storage devices such as batteries, loads such as motors, pumps or other devices and/or a local microgrid or public grid(s) (see FIG. 3 for an example).

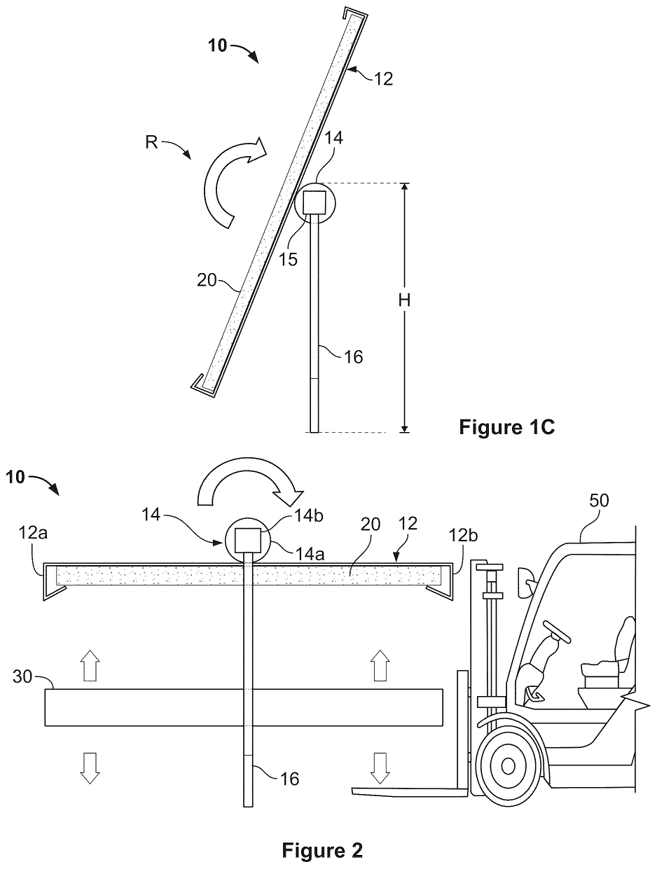

FIG. 2 shows how a support platform or pallet 30 may be provided under the supported table 12 and string 20 once the table 12 and string 20 have been rotated to an inverted position with the PV string 20 facing downward. The pallet 30 is then raised until contacting the module 20 at which time the string 20 is released from the table 12 by disengaging and/or releasing from the supports 12a, 12b. The pallet 30 is then lowered to remove the string 20 from contacting the table 12 so the pallet 30 and string can be moved. In this exemplary embodiment, the table 12 and string 20 are rotated to a horizontal, downward facing position. In other embodiments, the table 12 and string 20 may not be rotated to a completely inverted, horizontal position but to a downward facing position with the pallet 30 in a parallel relationship thereto so the pallet 30 may be raised or the table 12 and module 20 lowered so as to position the PV string upon the pallet 30. For example, the table 12 and string 20 may be in a 45 degree inclination relative to the ground. In this exemplary embodiment, the pallet 30 is raised by a forklift 50. In other embodiments, the pallet 30 may be raised by other elevation/support devices such as but not limited to a forklift, a jacking system, or other raisable devices.

In this exemplary embodiment as shown in FIG. 2, the string 20 is the first string to be loaded/placed upon the pallet 30. In other embodiments, the string 20 may be the first string to be loaded upon a pallet. This process can be repeated so two or more strings can be placed or stacked upon the pallet. In an embodiment, 5 to 25 strings may be stacked upon a pallet.

FIG. 3 illustrates a ganged PV system 100 that includes a PV string 101 supported above the ground by supports 105. The supports 105 are attached to the ground by any suitable attachment configurations including but not limited to attachment to ground anchors, ground penetration based foundations and/or by ballast. In this exemplary embodiment, the PV string 101 includes three PV modules 103 electrically and physically connected by module connectors 115. In this exemplary embodiment, the module connectors 115 includes cables and wires to mechanically support and electrically connect the modules 103. In other embodiments, the connectors 115 may include rigid components so as to mechanically, rigidly connect the modules.

The modules adjacent to the supports 105 are physically connected to the supports 105 by support connectors 115 connected to attachment sleeves or collars 117. In this exemplary embodiment, the support connectors 115 include flexible cables and wires to move with the PV string 101 should the PV string 101 sway or move relative to the fixed supports 105. This dampens the PV array 101 from wind loads or other movement.

In other embodiments, the connectors 115 may include rigid members and/or may be connected to cross beams attached to the collars 117 or other vertically moveable devices attached to the supports 105 to minimize string twist. In an embodiment, the attachment points to the supports may be fixed, such as eyebolts or other attachment points that are not vertically moveable along the supports 105. In other embodiments, cables or other connecting members attached to the supports 105 or other anchors may be used to stabilize or limit the motion of the string 101.

The collars 117 may also include electrical connectors that attach to the string 101. In this exemplary embodiment, one of the collars 117 is electrically connected to a battery 111 to store energy collected by the sting 101. In other embodiments, the PV string 101 may be connected through a support brace or may be directly connected to an external load such as but not limited to a battery, load, grid or microgrid. In this exemplary embodiment, the support braces 117 and string 101 are at a fixed height above the ground. In other embodiments, the support braces 117 may be vertically movable along the supports 105 so as to allow the braces 117 and module 101 may be raised above and/or lowered towards the ground.

FIG. 3 also illustrates the assembly of the ganged PV system 100 according to an embodiment of the disclosure. The assembly method includes providing a forklift 50 loaded with a plurality of PV stings 101. Each PV string 101 includes three PV modules 103. In other embodiments, the forklift 50 may be loaded with one or more PV stings and each PV string may include one or more PV modules. In other embodiments, the delivery of the PV strings may be made by another delivery platform such as but not limited to a forklift or a truck with a crane or other lifting device. The forklift 50 is shown after the forklift has positioned the sting 101 between the supports 105 and the sting has been mechanically and electrically connected as shown.

In this exemplary embodiment, the support connectors 115 were attached to the string 101 after the sting 101 was positioned between the supports 105. In other embodiments, the support connects 115 may be initially attached to the string 101 and then attached to the positioned supports 105. The string 101 may be positioned at a height allowing for various activities to occur underneath. For example, the string 101 may be positioned at a height allowing for crops to grow and/or be shaded underneath and/or for equipment to move underneath or any other dual use of land configuration, rough terrain previously thought to be unusable, and where land can also include water such as streams, rivers, canals, laterals to name a few.

### Example

In the following example, a PV string was constructed of multiple modules (approx. 1 m×2 m each), side by side, in portrait orientation with the modules placed generally vertically with module rear facing out horizontal to the ground. The modules were prepped for tensile support member installation by using four eyebolts at each module rear. The tensile support members were prefinished on one end with tension adjusters routed through eyebolts. A harness was constructed that included cable(s) pre-strung with eye bolts. The eye bolts were mounted on a flat piece of steel and the distance between eye bolts aligned with pre-drilled mounting holes for the module with adequate thread remaining for a retaining nut/washer. With modules in place, the assembly jig can be rotated to the horizontal. This allowed the installer to lay the harness on top of the modules and grab the flat piece of steel, guide the steel and eye-bolt through the pre-existing from manufacturer holes at the rear of each module 103 to readily fasten the support connector 115, or cables or tensile members, to the modules creating the mechanically pre-assembled string.

In this example, it is demonstrated that a “harness” including cables and a fastening means may be pre-assembled for faster installation, additionally a “quick connect” eyebolt, or clamp with an eyelet, may be used where an eye bolt with a spring loaded fastening mechanism may simply be pushed through the module mounting hole. In various embodiments, modules and conductors are wired, parallel, series or combination thereof and wire managed. Module to module and module to tensile member grounding bonds are or may be installed. Unfinished tensile member ends may be thimble or swage finished.

Tensile member ends are pulled taut against jig and jig rotates approximately 90 degrees thereby placing the preassembled string horizonal and face up for a waiting pallet. Pallet is brought to a close proximity to the pre-assembled string, typically just below the string. Support arms release the string from the jig allowing string to settle upon the pallet. Tensile member ends are released from jig, pallet moves to allow jig to rotate back to near vertical and process repeats. Number of arrays per pallet dependent on field support post height above grade. For example, post heights of 1.5 m would accommodate pallet (0.125 m ht.), 12 arrays with spacers (0.0625 m ht. each) and necessary cable sagitta (0.5 m ht.) for installation. 12 arrays would be nearly 50 kW name plate output. 3 such pallets, 150 kW, can be carried by typical “carry-all” 53′ trailer depending on OTR height restrictions and maximum weight (+/−5000 Kg per pallet) site conditions allow.

Loaded pallets are manipulated with forklift, telehandler or similar equipment equipped with fork spreaders for enhanced control. On-site forklift will benefit from pneumatic tires due to variations in terrain. With this approach, installations can start/terminate at substations, or power can be fed back to diminish line loss. At site, a forklift would retrieve loaded pallet from carry-all trailer and maneuvers in between first set of posts. Pallet raised/lowered to be in line with post connections-fixed steel angle for fixed tilt and rotating steel angle, “rotational arms” for single axis tracking. With string flat and tensile members slack string is connected to steel angles or support braces 117. Use of turnbuckles increases tensile member tension while lowering pallet to clear array sagitta. Turnbuckles are not necessary for large utility scale deployments. Forklift deploys all strings on the pallet and repeats the process at next bay between posts.

This application demonstrates the rapid deployment of pre-assembled, pre-wired/grounded PV arrays with the use of the invention. The arrays of many modules pre-assembled at a central location or on/near a utility site reduces labor and inclement weather down time.

In this example, pre-assembled ganged PV palletized strings are shipped with up to approximately 25 strings per pallet to the install location. Pallets are deployed at the install location with one driver operating the forklift or telehandler and two installers, one at each end of a PV string, connecting panel connectors to support braces and then to prepositioned supports. This methodology is simple, essentially “plug and play” and optimized. The invention seeks to assemble and deploy at the string, rather than module level, while maintaining plug and play simplicity.

The invention being thus described, it will be obvious that the same may be varied in many ways. Such variations are not to be regarded as a departure from the spirit and scope of the invention, and all such modifications as would be obvious to one skilled in the art are intended to be included within the scope of the appended claims. It is intended that the scope of the invention be defined by the claims appended hereto. The entire disclosures of all references, applications, patents and publications cited above are hereby incorporated by reference.

In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A jig, comprising:
a table;
a support configured to attach at least one photovoltaic (PV) module to the table; and
a support system configured to elevate the table above a horizontal surface;
wherein the support system comprises vertical supports attached to a cross-member and a rotational device attached to both the table and cross-member that allows the table to rotate about the cross-member without impacting the horizontal surface.

2. The jig of claim 1, wherein the at least one PV module comprises two or more PV modules forming a PV string.

3. The jig of claim 1, further comprising clamping devices attached to the table for attaching the at least one PV module to the table.

4. The jig of claim 1, wherein the table can be rotated to an inverted position.

5. A method of assembling a photovoltaic string having one or more photovoltaic (PV) modules for installation, comprising:
attaching the one or more PV module to a table so a surface of the PV module faces away from the table;
rotating the table so the surface of the PV module faces downward;
providing a support platform parallel to the surface;
bringing the surface in contact with the support platform; and
disengaging the one or more PV module from the table.

6. The method of claim 5, wherein the one or more PV modules is two or more PV modules forming a PV string.

7. The method of claim 5, wherein the support platform is a pallet.

8. The method of claim 5, wherein the support platform is provided by a forklift.

9. A photovoltaic (PV) installation method, comprising:
loading one or more PV modules by a process comprising:
attaching the one or more PV module to a table so a surface of the PV module faces away from the table;
rotating the table so the surface of the PV module faces downward;
providing a support platform parallel to the surface;
bringing the surface in contact with the support platform; and
disengaging the one or more PV module from the table onto a support platform;
delivering the support platform supporting the one or more PV modules to a PV installation location;
positioning the support platform and one or more PV modules between PV supports;
attaching the one or more PV modules to the PV supports; and
separating the support platform from the one or more PV modules so the one or more PV modules are suspended between the PV supports.

10. The method of claim 9, wherein the one or more PV modules is two or more ganged PV modules.

11. The method of claim 9, wherein the support platform is a pallet.

12. The method of claim 9, wherein the support platform is delivered to the installation location by a mobile transport vehicle that comprises a lifting portion.

13. The method of claim 9, wherein the mobile transport is a forklift.
